(19) United States
(12) Patent Application Publication
(10) Pub. No.: US 2026/0295548 A1
(43) Pub. Date: Oct. 1, 2026

(54) SOLAR-POWERED FLEXIBLE WASTE-TO-FUELS PROCESS

(71) Applicant: University of Florida Research Foundation, Inc., Gainesville, FL (US)

(72) Inventors: Helena E. Hagelin Weaver, Gainesville, FL (US); Jonathan Scheffe, Gainesville, FL (US); Juan Claudio Nino, Gainesville, FL (US); James Arthur Trainham, Gainesville, FL (US)

(21) Appl. No.: 19/482,517

(22) PCT Filed: May 9, 2024
(86) PCT No.: PCT/US2024/028567

§ 371 Date: Nov. 7, 2025

Related U.S. Application Data
(60) Provisional application No. 63/465,021, filed on May 9, 2023.
(60) Provisional application No. 63/543,987, filed on Oct. 13, 2023.

(51) Int. Cl. B01J 8/06; B01J 6/00; B01J 23/10; B01J 23/755; C01B 3/061; C01B 3/32; C10B 53/00

(52) U.S. Cl. CPC B01J 8/067; B01J 6/008; B01J 8/065; B01J 23/10; B01J 23/755; C01B 3/063; C01B 3/32; C10B 53/00; B01J 2208/00451; B01J 2208/065; C01B 2203/0261; C01B 2203/1058; C01B 2203/1082

(57) ABSTRACT

Various examples are provided related to conversion of biomass and other carbonaceous sources using solar heat. In one example, a waste-to-fuel conversion method includes generating carbon-containing gases and vapors from a carbonaceous waste by pyrolysis; and converting the carbon-containing gases and vapors to carbon monoxide and hydrogen (synthesis gas or syngas) in a chemical looping cycle utilizing a reductionoxidation (redox) material. Heating for the pyrolysis and chemical looping cycle is provided by solar thermal energy via a thermal storage medium. In another example, a gasification process includes a pyrolysis reactor that can generate carbon-containing gases and vapors from a carbonaceous waste; and a chemical looping redox cycle that can convert the carbon-containing gases and vapors to carbon monoxide and hydrogen (synthesis gas or syngas) utilizing a redox material. Heating for the pyrolysis reactor and chemical looping redox cycle is provided by solar thermal energy via a thermal storage medium.

### CROSS REFERENCE TO RELATED APPLICATIONS

This application claims priority to, and the benefit of, U.S. provisional applications entitled “Solar-Powered Flexible Waste-to-Fuels Process” having Ser. No. 63/465,021, filed May 9, 2023, and Ser. No. 63/543,987, filed Oct. 13, 2023, both of which are hereby incorporated by reference in their entireties.

### BACKGROUND

Biomass gasification can be used to convert biomass into gas synthesis gas, which is further used to produce liquid fuels and chemicals, which can improve product quality and energy utilization efficiency. Pyrolysis and chemical looping reforming processes are part of the biomass gasification.

### SUMMARY

Aspects of the present disclosure are related to conversion of biomass and other carbonaceous sources using solar heat. In one aspect, among others, a waste-to-fuel conversion method comprises generating carbon-containing gases and vapors from a carbonaceous waste by pyrolysis; and converting the carbon-containing gases and vapors to carbon monoxide and hydrogen in a chemical looping cycle utilizing a reduction-oxidation (redox) material, wherein the carbon monoxide and hydrogen is a synthesis gas or syngas; where heating for the pyrolysis and chemical looping cycle is provided by solar thermal energy via a thermal storage medium. In one or more aspects, the redox material can be a metal oxide (MeOₓ). The metal oxide can further comprise an isovalent dopant, an aliovalent dopant, or any combination thereof. The metal oxide can further comprise a catalytic metal. The metal oxide can be CeO₂. The CeO₂ can further comprise the catalytic metal nickel. The metal oxide can be CeO_{2-d}, where d is less than 0.5. The CeO_{2-d} can further comprise the catalytic metal nickel.

In another aspect, a gasification process comprises a pyrolysis reactor configured to generate carbon-containing gases and vapors from a carbonaceous waste; and a chemical looping steam reforming (CLSR) cycle configured to convert the carbon-containing gases and vapors to carbon monoxide and hydrogen utilizing a reduction-oxidation (redox) material, wherein the carbon monoxide and hydrogen is a synthesis gas or syngas; where heating for the pyrolysis reactor and CLSR cycle is provided by solar thermal energy via a thermal storage medium. In one or more aspects, the redox material can be a multifunctional material with a catalytically active surface. The redox material can be a metal oxide (MeOₓ). The metal oxide can comprise an isovalent dopant, an aliovalent dopant, or any combination thereof. The metal oxide can further comprise a catalytic metal. The metal oxide can be CeO₂. The CeO₂ can further comprise the catalytic metal nickel. The metal oxide can be CeO_{2-d}, where d is less than 0.5. The CeO_{2-d} can further comprise the catalytic metal nickel. In various aspects, a separate stream of hydrogen can be added to the CLSR cycle and/or landfill gas can be supplied to the CLSR cycle.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a sustainable and renewable process for the production of synthesis gas (MeOₓ is a ceria-based metal oxide functionalized with an active metal and absorbent) and liquid fuels, in accordance with various embodiments of the present disclosure.

FIG. 2 illustrates the total specific moles of evolved species and CH₄ conversion during partial oxidation of methane (POM), in accordance with various embodiments of the present disclosure. Results are shown for Ni/CeO₂ (left) or CeO₂ (right) at various operating temperatures.

FIG. 3 illustrates another embodiment of the waste-to-fuels process, in accordance with various embodiments of the present disclosure.

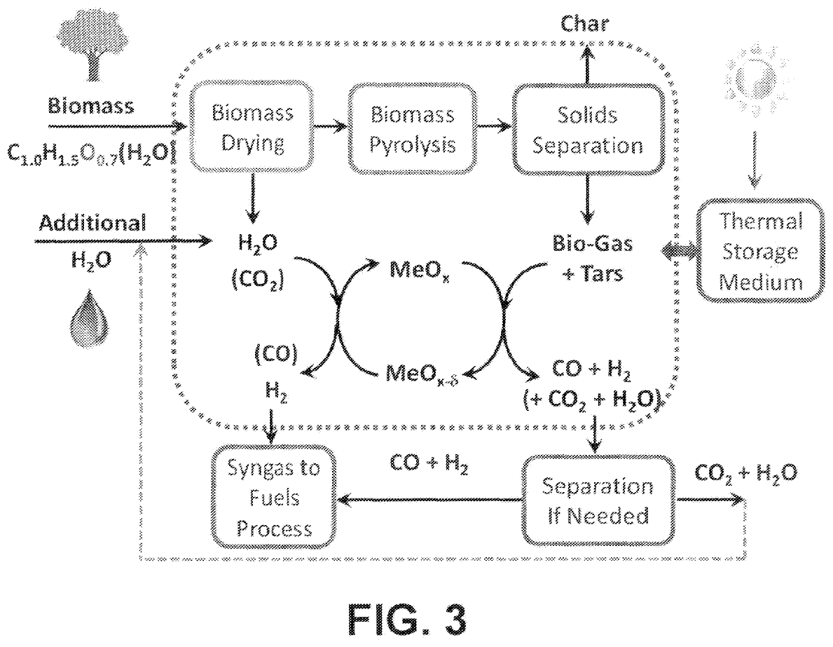

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

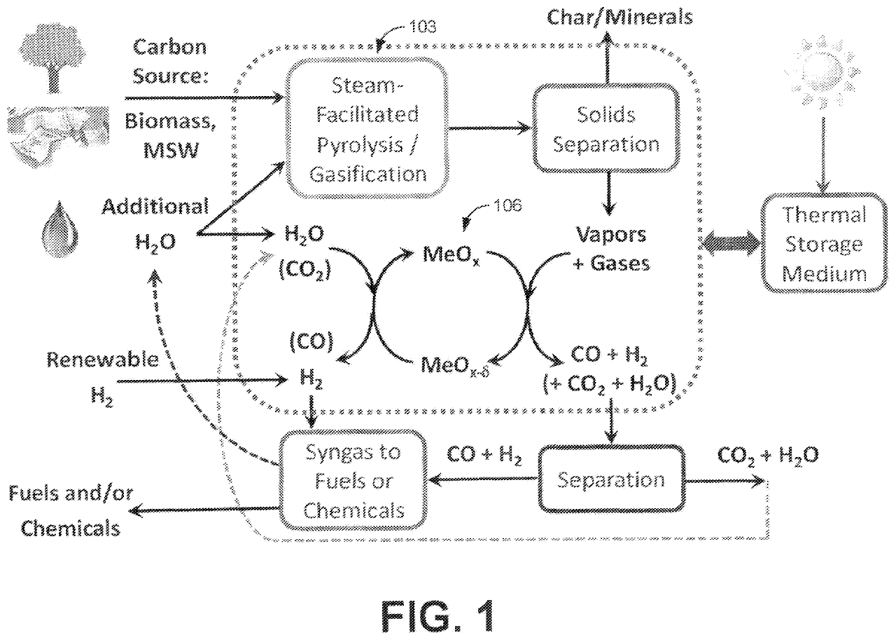

This disclosure is related to a new process using solar heat to convert biomass and other carbonaceous sources, such as the organic fraction of municipal solid waste (i.e., MSW), algal biomass or lignocellulosic biomass, and recyclable or non-recyclable plastics to produce high-quality chemicals or drop-in liquid fuels, which are particularly important for industries that are difficult to decarbonize, such as aviation and shipping (i.e., waste-to-fuels processing). The process converts biomass, or other carbon-containing sources, into synthesis gas (carbon monoxide and hydrogen) in two steps to facilitate and maximize carbon conversion to desired products and produce a synthesis gas that needs minimum conditioning and gas cleaning before entering the liquid fuels synthesis step (FIG. 1). In the first step, a steam-enhanced, high-temperature (fast) downdraft pyrolysis reactor 103 converts the biomass to vapor-phase carbonaceous compounds. Then, in a second step these products are converted into synthesis gas in a catalytically enhanced chemical looping steam reforming (CLSR) cycle 106. This CLSR cycle 106 is differentiated in two main ways from typical approaches utilized in biomass processing. First, a multifunctional material (MeOₓ) with a catalytically active surface helps remove contaminants present following pyrolysis. Second, the oxidation step of this CLSR cycle 106 splits additional H₂O (and recycled CO₂) to increase fuel yields, enabled by driving the process with solar heat. The combination and operation of the pyrolysis reactor with limited steam injection together with new materials for the chemical looping cycles offers advantages over typical approaches used in biomass processing. The use of a flexible redox material can improve the process.

The process efficiently overcomes the main challenges associated with the use of biomass (or MSW) and solar thermal energy in the production of high-quality liquid fuels, namely the intermittency of solar energy, the high oxygen content plus compositional variability of biomass or MSW, and the product gas impurities resulting from biomass pyrolysis or gasification. Each step in this process has been demonstrated at various technology readiness levels (TRLs). In the process, the biomass pyrolysis/gasification (TRL 6,7) can be optimized for operation with the chemical looping step. Chemical looping conversion of carbon-containing vapors has been demonstrated at TRL 4 or 5. In the process, the reduction-oxidation (redox) catalytic materials can also remove contaminants and this step is at TRL 2. Several existing plants (TRL 9) are currently producing aviation or diesel fuels at a large scale via Fischer-Tropsch synthesis.

Environmental impacts of the entire process can be minimized by tuning the steam-enhanced biomass pyrolysis process conditions to minimize char formation and optimize the overall process in terms of synthesis gas yield, process costs, and environmental impacts. The resulting process can reduce greenhouse gas (GHG) emissions compared to equivalent fossil fuels (e.g., diesel or aviation fuel). The process can have a significant biomass-to-syngas carbon yield and biomass to liquid fuels carbon conversion efficiency.

### Technical Description and Impact

While biomass conversion to power has been used commercially, biomass to liquid fuels is not a mature technology. Due to the high oxygen content of biomass and its compositional variability, biomass liquefaction to fuels is challenging as the bio-oils are highly corrosive, unstable and toxic, and require deoxygenation before they can be used as fuels. Moreover, the complexity of bio-oils, which comprise hundreds of compounds that vary with biomass source, makes selective hydrodeoxygenation to specific products challenging at best. Steam gasification to break down the biomass into synthesis gas that can be used in the production of high-quality liquid fuels is a promising alternative, but the reaction is highly endothermic and product gas cleaning to remove tars and other contaminants is very costly. Furthermore, due to the high oxygen content of biomass (average formula CH_{1.5}O_{0.7}), the best H₂:CO ratio that can be obtained is 1.05 (Equation 1).

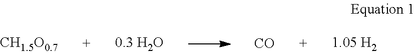

This is significantly lower than the 2:1 H₂:CO ratio needed for liquid fuels synthesis via the Fischer-Tropsch process (Equation 2).

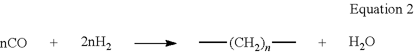

While the water-gas-shift reaction (CO+H₂O [symbol] CO₂+H₂) can adjust this ratio in the presence of excess steam, it would require converting >30% of the CO to CO₂. Therefore, to maximize the biomass conversion to liquid fuels and avoid significant CO₂ formation, an additional source of hydrogen is needed to adjust the H₂:CO ratio before F-T synthesis. The cost of hydrogen from different renewable sources should be included in the final cost of the produced F-T fuels.

Process Design. The proposed process can be designed to address the compositional variability of biomass (by breaking down the biomass components into synthesis gas and designing a reactor that can handle biomass with different bulk densities), while considering its high oxygen content. The use of a downdraft pyrolysis reactor avoids introduction of a fluidization medium. The endothermic reaction can be driven by solar thermal energy to avoid using biomass combustion to provide heat, as the latter increases CO₂ and H₂O formation and decreases the biomass-to-fuel yield. Finally, the multifunctional chemical looping redox material can be designed to operate as 1) oxygen carrier (OC), 2) catalyst that breaks down tars and nitrogenous compounds, improves the selectivity to synthesis gas, and enhances reaction rates to allow operation at lower temperatures, and 3) absorbent that reduces concentrations of N-, S- and Cl-containing contaminants. The chemical looping multifunctional material can enable the production of a synthesis gas that needs minimum conditioning, and the cyclic operation facilitates the regeneration of the dual redox/absorbent oxide materials. Importantly, in the second half cycle of the CL step, solar thermal energy can enable reoxidation of the redox material using H₂O and CO₂ to produce additional synthesis gas further increasing the biomass-to-fuel yield.

Overall, the process comprises four areas: pretreatment, pyrolysis/gasification, syngas purification, and fuel synthesis, where the syngas purification encompasses a cyclone for solids separation, chemical looping tar conversion plus contaminant removal, and any additional syngas cleaning needed before the F-T synthesis process. The pretreatment utilized can be standard for biomass and the Fischer-Tropsch synthesis of liquid fuels can be a commercial process (vide infra). Therefore, only the pyrolysis/gasification and syngas purification are discussed in this section. Dry biomass (no more than 7% moisture by weight) enters the pyrolysis unit, as this low moisture content will allow steam addition while maintaining control over the steam-to-biomass ratio in the reactor. Air is excluded to avoid adding inert gas (such as nitrogen) and additional oxygen to the process. The downdraft pyrolysis reactor can operate under high-temperature fast pyrolysis conditions to maximize vapor and gas phase products and minimize char. Superheated steam, generated using solar energy via the thermal storage medium, can be added to the pyrolysis reactor to provide in-situ heating and enhance the conversion of char and the heaviest tars to lighter vapor-phase products. By eliminating oxygen (air) and limiting the steam provided during the pyrolysis step, the H₂O content in the product stream and the overoxidation of the carbonaceous waste to CO₂ can be minimized. The pyrolysis reactor can also be indirectly heated by the thermal storage medium. Since the products from a pyrolysis or gasification process not only depend on the biomass source, but also the reactor configuration, it is important to evaluate the products formed in this specific pyrolysis reactor as a function of the biomass used, the residence time in the reactor, the reactor temperature, the amount of steam injected, and the steam temperature. The conditions can be optimized together with the performance of the chemical looping step to obtain a more energy efficient and cost-effective process with minimized environmental impacts.

Any char and ashes that are formed can be separated using a cyclone (heated to prevent condensation of tars) before entering the packed bed chemical looping reactors. The redox material (OC) can be placed inside tubular reactors and indirectly heated by the thermal storage medium in a tube-and-shell type heat exchanger. In the first half cycle of the chemical looping process, the vapor phase products (tars with a general formula of CH_{y}O_{z}) can be partially oxidized to CO and H₂ by reacting with the MeOₓ redox ceramic material (Equation 3). The catalytically enhanced surface can facilitate complete conversion of the carbon containing compounds to carbon monoxide and hydrogen and reduce the temperature of operation.

$${CH}_{y} {O}_{z} + ( \frac{1 - z}{δ} ) {MeO}_{x} \to CO + \frac{y}{2} {H}_{2} + ( \frac{1 - z}{δ} ) {MeO}_{x - δ} \qquad Equation 3$$

Overoxidation to CO₂ and H₂O can occur during this step, but the chemical looping cycle can be operated to minimize formation of combustion products, for example by carefully controlling and limiting the oxidation state of the OC during the reaction. Furthermore, the redox material can be designed to break down and remove common biomass contaminants, mainly N- and S-containing compounds. The redox material also has the potential to remove other possible contaminants, such as chlorinated compounds, that are likely to be present in higher concentrations, for example in MSW. The first chemical looping half cycle can be operated in such a way that tars are eliminated, residual CO₂ and H₂O are minimized, and most of the N-, S- and Cl-containing compounds are either decomposed to N₂ or adsorbed by the redox material (S and Cl-containing compounds) to allow minimum use of standard gas cleaning equipment following this step.

By utilizing solar thermal energy as an external heat source to drive the endothermic reaction steps and preheat any feed streams, the reduced OC (MeO_{x-δ}) can be reoxidized in the second half cycle by recycled steam, and potentially also recycled CO₂ rather than O₂. This produces additional H₂ (and CO, if CO₂ is recycled) as shown in Equations 4 and 5, and prevents overoxidation of the oxygen carrier, which enhances the selectivity to CO and H₂ in the following half cycle. The H₂ (and CO) produced in this step can be fed to the fuel synthesis step, together with any additional renewable H₂ to adjust the H₂-to-CO ratio for the F-T process.

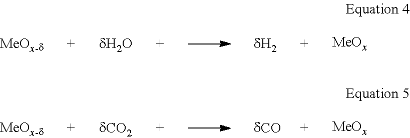

The subsequent Fischer-Tropsch (F-T) synthesis of liquid fuels also produces water as a byproduct (Equation 2). This water can be fed back into the system to minimize the amount of additional water that is required for the overall process (FIG. 1). The requirements for feed stream compositions, product yields, and process requirements are already known. However, this step is useful to further evaluate the economics and environmental impacts of the overall process.

The energy needed for heating the entire process is provided by solar thermal energy by utilizing a thermal storage medium, which allows for 24/7 operation and addresses the challenge with the intermittency of solar irradiation. Using solar energy also eliminates the need for combusting a fraction of the carbonaceous waste source to provide the heat of reaction, and therefore increases the carbon conversion efficiency (i.e., the fraction of carbon from the carbonaceous waste source that is converted to useful carbon-based products, mainly carbon monoxide).

Chemical looping gasification and chemical looping tar conversion have been investigated, but most of the processes use air to reoxidize the oxygen carrier (with steam added in the first rather than the second half cycle, or even in a third reactor). This adds oxygen to the overall reaction and, therefore, increases CO₂ production and decreases the overall biomass-to-fuel yield compared with the proposed process. The most relevant process for comparison is the fluidized-bed steam gasification of biomass, and although this could be operated as a one-step process, insufficient conversion of tars requires a secondary catalytic tar removal reactor. There are several advantages of the two-step steam-enhanced pyrolysis plus chemical looping steam reforming of the pyrolysis products over the conventional steam gasification with catalytic tar removal: 1) Improved flexibility in the biomass feedstock that can be used (allowing for biomass with low bulk density to be used). 2) The vapor phase product stream does not contain added inert gas that must be removed before the F-T process, since air or nitrogen is not used for fluidization. 3) The product gas has a lower CO₂ content compared with air-blown or steam gasification of biomass using a fluidized bed (the amount of steam injected in the proposed process is limited and uncoupled from the amount needed for fluidization). 4) The CLSR step affords a more efficient use of catalytic materials in the breakdown of tars and nitrogenous compounds and results in significantly improved carbon conversion efficiency. It can also reduce the temperature of operation, which improves the energy efficiency. The same catalyst could not be used in a one-step steam gasification process, since the catalyst would suffer from attrition and would quickly deactivate in the gasifier, either via coking or poisoning by contaminants. This would be even worse if contaminated biomass or MSW is used as the carbon feedstock. By utilizing a separate CLSR cycle, any carbon that is deposited on the redox materials during the first half cycle, is removed in the second half cycle and the redox material is regenerated. The presence of contaminants may also poison the catalytic material, but the cyclic operation allows for the addition of a separate catalyst regeneration step, which also removes the contaminants from the product stream (vide infra). Furthermore, by operating this step as a packed bed reactor, only a portion of the redox material will be exposed to the contaminants (and again, the introduction of a fluidization medium is avoided). 5) The cyclic operation in the proposed process facilitates regeneration of the catalytic redox material, which is more difficult in the conventional steady-state, catalytic, hot-gas cleaning process. This is important since coking (carbon deposition) is one of the main deactivation pathways of tar reforming catalysts. It should be noted here that operating the conventional catalytic hot gas cleaning in a chemical looping cycle after the fluidized bed of a steam gasification reactor would likely decrease the selectivity to synthesis gas, as more of the CO and H₂ would be exposed to the oxidized redox material. 6) The cyclic operation will also facilitate removal of N-, S- and Cl-containing compounds, as the versatile redox material can be designed to function as an absorbent and remove contaminants via an adsorption-desorption process. 7) By converting the majority of the tars and bio-oils in the second reactor, the biomass reactor can be operated at lower temperatures, thus increasing the energy efficiency and facilitating the use of solar thermal energy. 8) Finally, a multi-step process allows separate tuning of the reaction temperature in each step for optimum performance of the overall process.

Rather than trying to selectively produce fuels or chemicals by directly converting complex mixture of carbonaceous species in waste streams of varying composition or their resulting pyrolysis products, which comprise hundreds of different compounds, including unstable, corrosive and highly toxic components, the process efficiently decomposes the biomass components into simple molecules (CO and H₂) that serve as building blocks for high-quality liquid fuels or chemicals. This affords more control over the products that are formed, and commercial processes to convert synthesis gas to chemicals and fuels have already been developed, such as, methanol synthesis and Fischer-Tropsch synthesis of liquid fuels.

Another challenge with synthesis gas derived from oxygen-containing carbonaceous waste is the low H₂ to CO ratio that is obtained in the products stream when the formation of CO₂ is minimized (typically on the order of H₂:CO of 1:1). This ratio can be adjusted by the water gas shift reaction (H₂O+CO [symbol] H₂+CO₂) by adding more steam to the process. However, this results in the formation of undesirable CO₂ and reduces the carbon conversion efficiency (the yield of carbon monoxide from the carbonaceous source). In some places this may be the only way to operate and, if needed, the CO₂-rich product stream can be sequestered. However, the specific process design allows for better control of the overall process (compared with a one-step steam gasification process) and facilitates tuning of the H₂:CO ratio. To maximize conversion of the carbonaceous waste to carbon monoxide, a separate stream of hydrogen would be needed and added to the syngas conversion step to allow careful tuning of the H₂:CO ratio. This hydrogen would need to be produced via renewable processes, such as, solar- or wind-driven electrolysis. Landfill gas could also be supplied to the first half cycle in the chemical looping step, since this would increase the H₂:CO ratio (as shown in Equation 6). It is important to note that plastic waste with low oxygen content (such as polyethylenes, polypropylenes, polystyrenes, and similar plastics) would reduce the amount of supplemental hydrogen needed for an optimum syngas to fuels process.

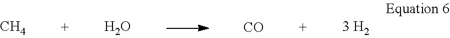

Feasibility. The downdraft biomass gasifier is simple and flexible in its operation. By superheating the steam, some direct heating is supplied in the gasifier without combusting any biomass. Indirect heating can also be provided via the thermal storage medium.

A large number of different chemical looping processes have been investigated, ranging from chemical looping combustion, partial oxidation, steam reforming and dry reforming of different carbonaceous species, such as methane, model tar compounds or biomass. A particularly useful oxygen carrier material is cerium dioxide (ceria or CeO₂), as evidenced in its use in thermochemical water and carbon dioxide splitting, as well as the chemical looping reforming of methane. The oxygen mobility and storage capacity of ceria are important in chemical looping reactions and can be improved by doping. Several aliovalent (e.g., Nd, La, Sm, Ca) and isovalent (e.g., Zr, Hf) dopants also improve the thermal stability of the resulting compound. Particularly interesting is Ca-doped CeO₂, since in addition to improving the redox properties of CeO₂, Ca can facilitate absorption of CO₂, H₂O, S- and halogen-containing species.

The breakdown of tars can be further enhanced with the addition of catalytic metals (such as Ni or Fe) to the CeO₂ surface. Several Ni- and Fe-containing oxides, typically spinels or perovskites, have been used in chemical looping reactions of biomass or model tar compounds. Nickel is more selective to synthesis gas (CO and H₂) and a more effective methane activation catalyst, but cannot be reoxidized by H₂O or CO₂ in the second step. However, by supporting Ni on a reducible support, such as CeO₂, which can be reoxidized by H₂O or CO₂, strong metal-support interactions result in transfer of oxygen and hydrogen between CeO₂ and Ni, and renders interfacial sites very active, thus allowing the use of Ni/CeO₂ materials in chemical looping steam and dry reforming reactions. Iron is a very efficient H₂O and CO₂ splitting material, but is typically less thermally stable compared with Ni. Both metals are prone to deactivation by coking (carbon deposition) under reducing conditions, but the use of reducible supports, such as CeO₂, and high metal dispersions can mitigate severe coking and cyclic operation facilitates carbon removal.

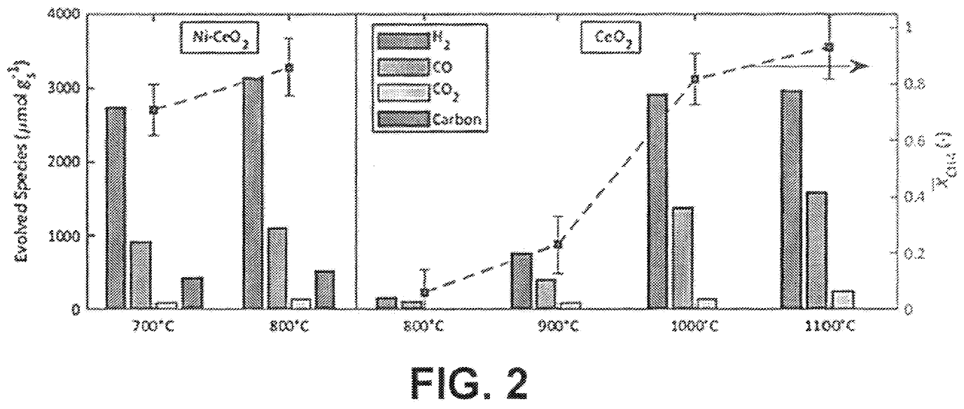

Ni-enhanced CeO₂ (ceria) is very efficient in activating methane compared with pure ceria (FIG. 2). Synthesis gas production is much faster over the Ni-enhanced ceria and thus allows reaction at lower temperatures. By optimizing the oxidation state it has been shown that full combustion to CO₂ or H₂O can be suppressed, to obtain selectivity greater than 98 to CO % and 90% to H₂. Exemplary results demonstrating improved conversion of Ni/CeO₂ at lower temperatures (e.g., 700° C. versus 1000° C.) compared to CeO₂ are shown in FIG. 2. One distinguishing feature of the Ni/CeO₂ is the carbon formation, but this is completely removed upon re-oxidation with CO₂ to form additional CO. Further, it can be almost completely mitigated (if desired) by limiting the reaction time such that CH₄ conversion is <100%, as most carbon formation occurs after reduction is completed.

Ni/CeO₂ materials are important as Ni can also break down nitrogen-containing compounds (in addition to tars) and convert the resulting NH₃ and HCN to N₂. In addition, removal of sulfur contaminants (mainly H₂S) is possible over these catalysts, although in this case it is possible that the sulfur will block active Ni (or Fe) sites.

Pretreatment can be based on the NREL report for fast pyrolysis of lignocellulosic residues. It can contain a system for biomass grinding and a contact drier. Dry biomass can be fed to the pyrolysis/gasification area, and a product distribution similar to the one obtained in pyrolysis can be assumed (~10% water, 16% char, 13% gas, and 61% tars on a dry biomass basis). Solids present in the pyrolysis products can be removed using a cyclone, and the tars can be transformed into syngas using a chemical looping bed (CL) loaded with CeO₂. It can be assumed that the conversion of tars to syngas in the CL bed is stoichiometric and no undesirable byproducts (e.g., CH₄ and CO₂) will be obtained.

The CL step operates as a cyclic dynamic system. Two beds are needed, while one is operated in reduction mode, the other is in oxidation mode. The oxidation mode utilizes water and waste CO₂ produced in the different units of the process to oxidize the redox material. In the final area, the cleaned syngas is transformed into liquid fuels using the Fischer-Tropsch reaction. Waxes produced can be cracked to increase fuel yield, and light gases (CH₄) can be converted to syngas by feeding them back to the chemical looping system, or the pyrolysis reactor (if needed for fluidization).

Innovation and Impacts. The design of this project includes a unique two-step steam gasification process, which uses steam-enhanced gasification combined with a chemical looping redox cycle and allows the efficient use of solar thermal heat to improve the overall biomass conversion to fuels. The development of the advanced and flexible redox materials for the chemical looping process is novel, as they will serve as catalysts, oxygen carriers, and absorbers. More specifically, the new materials will be multifunctional to allow more efficient breakdown of tars and conversion of carbonaceous compounds to synthesis gas, while at the same time facilitating removal of contaminants. The result is a biomass to liquid fuels process with a lower environmental impact (driven by solar energy) and with improved biomass conversion efficiency to desired products (synthesis gas and liquid fuels), reduced operating temperatures (more energy efficient), and a cleaner synthesis gas (complete tar removal and lower concentrations of contaminants compared with conventional fluidized-bed steam gasification of biomass, which is important since the cost of cleaning biomass-derived synthesis gas is significant) which is closer to the requirements of the Fischer-Tropsch process: total sulfur ≤50 ppb, halogens <0.1 ppm, alkali: <0.1 ppm, NH₃, HCN: <1 ppm, NOₓ, N₂O: <0.1 ppm, particulates: <0.1 mg/Nm, and tars: <1 ppm mol.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A waste-to-fuel conversion method, comprising:
generating carbon-containing gases and vapors from a carbonaceous waste by pyrolysis; and
converting the carbon-containing gases and vapors to carbon monoxide and hydrogen in a chemical looping cycle utilizing a reduction-oxidation (redox) material, wherein the carbon monoxide and hydrogen is a synthesis gas or syngas;
where heating for the pyrolysis and chemical looping cycle is provided by solar thermal energy via a thermal storage medium.

2. The method of claim 1, wherein the redox material is a metal oxide (MeOₓ).

3. The method of claim 2, wherein the metal oxide further comprises an isovalent dopant, an aliovalent dopant, or any combination thereof.

4. The method of claim 2, wherein the metal oxide further comprises a catalytic metal.

5. The method of claim 2, wherein the metal oxide is CeO₂.

6. The method of claim 5, wherein the CeO₂ further comprises the catalytic metal nickel.

7. The method of claim 2, wherein the metal oxide is CeO_{2-d}, where d is less than 0.5.

8. The method of claim 7, wherein the CeO_{2-d} further comprises the catalytic metal nickel.

9. A gasification process, comprising:
a pyrolysis reactor configured to generate carbon-containing gases and vapors from a carbonaceous waste; and
a chemical looping steam reforming (CLSR) cycle configured to convert the carbon-containing gases and vapors to carbon monoxide and hydrogen utilizing a reduction-oxidation (redox) material, wherein the carbon monoxide and hydrogen is a synthesis gas or syngas;
where heating for the pyrolysis reactor and CLSR cycle is provided by solar thermal energy via a thermal storage medium.

10. The gasification process of claim 9, wherein the redox material is a multifunctional material with a catalytically active surface.

11. The gasification process of claim 9, wherein the redox material is a metal oxide (MeOₓ).

12. The gasification process of claim 11, wherein the metal oxide comprises an isovalent dopant, an aliovalent dopant, or any combination thereof.

13. The gasification process of claim 11, wherein the metal oxide further comprises a catalytic metal.

14. The gasification process of claim 9, wherein the metal oxide is CeO₂.

15. The gasification process of claim 14, wherein the CeO₂ further comprises the catalytic metal nickel.

16. The gasification process of claim 9, wherein the metal oxide is CeO_{2-d}, where d is less than 0.5.

17. The gasification process of claim 16, wherein the CeO_{2-d} further comprises the catalytic metal nickel.

18. The gasification process of claim 9, wherein a separate stream of hydrogen is added to the CLSR cycle.

19. The gasification process of claim 9, wherein landfill gas is supplied to the CLSR cycle.
